(19) United States
(12) Patent Application Publication
(10) Pub. No.: US 2017/0275546 A1
(43) Pub. Date: Sep. 28, 2017

(54) PROCESS FOR THE REMOVAL OF H2S FROM SOUR GAS WHILE LIMITING SCAVENGING CHEMICALS

(71) Applicants: John F. Schartz, Midland, TX (US); John Patrick Schartz, Midland, TX (US); Levi R. Houk, Midland, TX (US)

(72) Inventors: John F. Schartz, Midland, TX (US); John Patrick Schartz, Midland, TX (US); Levi R. Houk, Midland, TX (US)

(21) Appl. No.: 15/076,733

(22) Filed: Mar. 22, 2016

(51) Int. Cl. C10L 3/10; B01D 53/14

(52) U.S. Cl. CPC C10L 3/103; B01D 53/1468; B01D 53/1493; B01D 2252/20436; C10L 2290/545

(57) ABSTRACT

An H₂S stripper that utilizes random packing material in the center column to greatly increase the conversion of H₂S gas to a solid form of sulfur. A thin film of scrubbing solution coating the packing material allows for a more efficient process of H₂S scrubbing that can reduce the chemical consumption rates of traditional, commercially available sulfide scavengers by 25 to 60%. This unit also allows for an easy clean out and is built to handle the pressure extremes that could be encountered in oil wells and/or gas wells, gas plants, offshore rigs, gas gathering systems, or pipe lines while not having any mechanical parts. This invention improves the H₂S removal process and reduces the amount of H₂S in natural gas streams as well as reducing the amount of treating chemicals.

### FIELD OF THE INVENTION

This invention provides an easy, cheap, and environmentally safe alternative to the removal of Hydrogen Sulfide (H₂S) from sour gas found in oil wells and gas wells.

This unit is small enough, that it can be placed in the oil field next to the pumping units and can work in unison with the pumping units, cleaning the gas as it leaves the oil and/or gas well. The unit can be expanded to accommodate larger applications as well, such as gathering systems, gas plants, offshore rigs and natural gas processing facilities. It can be sized to meet the accommodations of both gas flow rates and H₂S concentration. This invention is simplistic enough that it requires no mechanical parts, which allows for easy adaptability to established oil and/or gas well lines and reduces maintenance on the unit.

By the removal of H₂S from the resultant gas, the gas is of more value to the well operator because it can be sold for greater profits because the H₂S has been removed prior to refining. During refining H₂S can be bad by poisoning the expensive precious metal catalyst and corroding the steel tubing of the chemical plant.

### BACKGROUND OF THE INVENTION

There are several ways to chemically treat H₂S gas through the means of scavenging solvents, examples include using formaldehyde, zinc oxide, iron oxide, sodium nitrite and triazine. But all of these have their limitations and problems. These limitations include carcinogenic chemicals for formaldehyde, disposal problems for the metal oxides, NOₓ formation for the sodium nitrite, and expense for the triazine.

The removal of H₂S from natural gas has long been researched and many patents have been disclosed to assist in removing this chemical from natural gas streams. In the following paragraphs previous patents will be discussed, which will include how they are limiting and need improvements, followed by an explanation on why a new process needed to be developed.

U.S. Pat. No. 3,362,133 discloses a method of removing H₂S gas from a stream of H₂S and CO₂ with a solvent, such as a dialkyl ether. They claim that they use a series of equipment to achieve their removal of H₂S, one uses a recycled stream of their dialkyl ether, another adjusts the pressure of the gas stream to remove other gases from the gas stream, and using oxygen gas in a stripper to remove more of the H₂S gas stream.

U.S. Pat. No. 5,718,872 discloses that the removal of H₂S and other gas components of a gas stream can be selectively removed to isolate H₂S by means of a sulfur recovery unit. The sulfur recovery unit includes an absorber that has an affinity for H₂S over the other gas products. Then the gas stream with the H₂S absorbed is then placed into a heat exchanger and then passed through a stripper where more H₂S is removed from other gases that may have been absorbed in the first unit. Other streams can be recycled and be put in series depending on the concentration of H₂S in the gas stream.

U.S. Pat. No. 5,928,620 discloses a method of using a single stage reactor to remove H₂S from a gas stream. The inventors use the reaction of H₂S and SO₂ to produce a product of elemental sulfur and water. However, before the H₂S is ready to react in the single state reactor with the SO₂, the H₂S must be absorbed and isolated from the gas stream. Complicating this reaction for use in the oil field.

U.S. Pat. No. 6,495,117 B1 is an extension of the previous patent above, U.S. Pat. No. 5,928,620, by the same inventor. The inventors disclose the same reaction as above, the reaction of H₂S and SO₂, but now they incorporate a liquid organic solvent that contains a catalyst to promote the reaction. The organic solvent is usually in the diethyl ether family while the homogenous catalyst is 3-(hydroxymethyl)pyridine.

U.S. Pat. No. 8,883,036 B2 discloses an invention that separates H₂S from a gas stream, the sour gas stream is fed into another stream that contains a liquid amine stream. After this contact, the H₂S and amine stream then go to a hydrogen rich stream. The hydrogen reacts in a reactor to remove the H₂S from the gas stream. Then the resulting gas, if enough of the sulfur is removed, the gas can be processed at the refinery. This invention, in the reactor uses a packing to help with the reaction. The packing material is held in place in the reactor by screens.

U.S. Pat. No. 6,663,841 B2 Baker Hughes Inc. discloses that triazine, is a chemical that can be effectively used to treat H₂S from gas streams from natural gas and oil wells. Establishing that triazine is an industry standard chemical used to treat H₂S from oil and gas wells.

U.S. Pat. No. 2013/0001135 A1 discloses an invention that uses a packed bed scrubber filled with an inert substance to remove H₂S from the liquid fuel streams containing dissolved sulfur. They complete this separation without the use of a caustic solution, but with a counter flow of an inert gas, such as nitrogen or other inert, non-reactive gas.

While these inventions may be successful in removing large amounts of H₂S from sour gas streams, they are either complicated, by having recycle streams and multiple units, requiring pressured gas and possible other chemicals present to achieve the removal of H₂S. To be successful in removing H₂S, while using industry proven techniques, and being simple and cost effective, the footprint of the invention needs to be small. The invention needs to be uncomplicated and easily connect and be adaptable to natural gas streams in the oil field, including those that are already in service. Being forward thinking and being environmentally cautious is also needed for the next generation of environmental regulations that may come out to combat the emission of potential global warming chemicals.

In order to limit the amount of chemicals used, to be environmentally friendly and keeping expenses to a minimum, while still being effective as a H₂S scavenger, a new process needed to be developed that can be used in the oil field. Utilizing the proven chemical scavengers that are already available on the market to treat H₂S gas, this invention detailed below limits the amount of chemicals used to remove similar amounts of H₂S sour gas streams while also having no mechanical parts to complicate the process.

### SUMMARY OF THE INVENTION

To overcome these obstacles presented previously, this invention provides a cheaper and environmentally friendlier process to remove the unwanted gas. We pack the column with random packing materials, these can either be metal, plastic or ceramic, depending on the application. Along with the packing materials, the traditional, industrial proven chemicals for H₂S removal are used, mostly triazine, but other liquid scavenging chemicals may also be used. The chemical coats the packing material to create a very favorable reaction environment. This unit is then placed in line with the natural gas lines to purify the gas stream of H₂S.

By using this invention, the chemical consumption rates of the sulfide scavenging chemicals can be reduced by 25 to 60%. This invention can be used in individual well flow-lines from oil and/or gas wells, but can be outfitted to be used in gathering systems, gas plants, offshore rigs and natural gas processing facilities.

By understanding the reaction of triazine, or other scavenging chemicals, and realizing that a greater surface area for the reaction to take place to ensure that all of the H₂S would come into contact with scavenging agent allowing for less chemicals to be used. This invention takes common engineering knowledge and practices and applies it to this problem, to create a new process to remove H₂S from sour gas streams. An improved process that will save on capital cost, by having smaller reaction vessels for their scavenging chemicals, and use less scavenging chemicals per day. The industry standard ratio of triazine, one example of a scavenging chemical, to H₂S is 20:1. Our process cuts that ratio in half, to approximately 10:1, depending on CO₂ levels in the gas stream.

### DRAWING DESCRIPTIONS

FIG. 1 is a schematic of the invention for the process of the removal of H₂S from the natural gas stream. FIG. 1 is a single tube/vessel packed reactor.

### DETAILED DESCRIPTION OF THE INVENTION

This invention is different from those previously patented and in the market today. This will be made clear in this section, based on previous sections and what is claimed in this patent. While slight modification may be made or constructed to change the described invention, this patent should be taken as a guideline and anything created within the spirit or the scope of this invention should fall under this patent. The description and drawings should be understood as an illustration of one example of the said invention in is not the sole, limiting case. Let it be known that the claims and illustration are a generic example of the invention and the language and description used to describe the invention are not limiting.

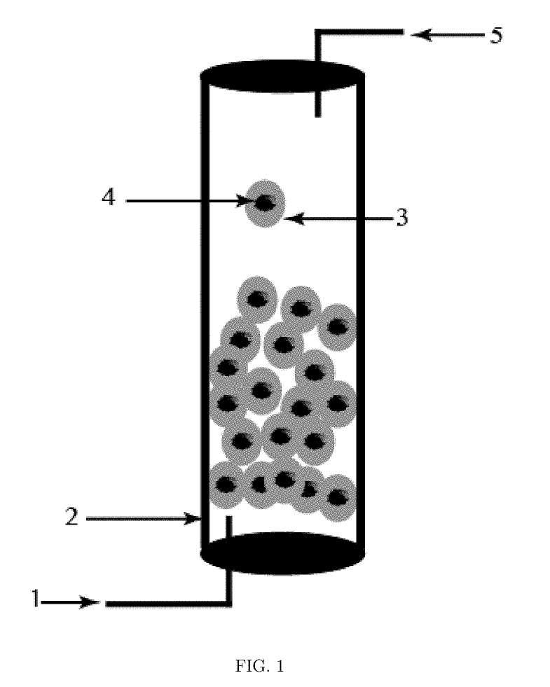

Referring to FIG. 1, the reactor for the process of stripping H₂S from natural gas. Natural gas from the gas lines enters the bottom of the reactor, 1. The natural gas can have any concentration of H₂S and CO₂ in it, along with other gasses commonly found in natural gas streams. The natural gas can have any type of flow rate, and with that a corresponding turbulent or laminar flow, for the said invention to work. The reaction vessels are custom made for specific applications and any pressure may be used that are commonly seen in the oil and gas industry.

Along with the natural gas entering the reactor from the gas line, labeled 1, the scrubbing chemical also enters the reaction vessel from this line. There are multiple ways to accomplish this task of getting a liquid droplet of chemical into a gas stream, including using an atomizer to emit either a fine mist spray continuously or intermittently, another is to slowly drip small amounts of chemical into the gas stream and allow the gas to pick up the liquid as it is passing by on the way to the reaction vessel. Other possibilities exist, but that is not the scope of this invention.

Referring to the pressure tested common steel reactor, 2, the reactor may be made from a long pre-ordered tube or a custom made welded tube manufactured for the specific application. This pressure tested common steel reaction vessel can be made of any thickness, to meet the pressure and flow rate demands of the application, generally the steel is constructed from J-55 or L-80 grade steel. The thickness of the steel vessel is dependent upon the specifications of the oil and/or gas well as defined by the ASME code. The outer diameter (O.D.) of the vessel can also be adapted based on the concentration of H₂S and the flow rate of natural gas, but generally it must be at least 4 inches in O.D. to accommodate the random packing materials and to ensure that there is not sufficient pressure drop in the reactor. The height of the reactor is also dependent on the application. For a single natural gas well, the vessel may only be 1 to 2 feet tall, for larger applications, the vessel may need to 4 to 7 feet tall. The diameter can also be widened to keep costs of fabrication and transport to a minimum.

The reaction vessel, 2, along with the contents inside of the reactor, are coated with a thin film of the scrubbing chemical, depicted in FIG. 1 as the dark gray shading, 3 around the random packings, 4. The scrubbing liquid reacts with the H₂S. The scrubbing liquid is commercially bought. The industry standard at the present time of the invention is triazine. While more modern scrubbers are surely being developed by other companies, this invention could use those that are being developed after testing for material and safety compatibility. The amount of scrubbing solution is dependent upon the conditions of the individual well, based on H₂S and the flow rate of gas, along with the packings that are used. With a higher surface area packing, it will take more liquid to coat all of the surfaces with a thin, reactive film of the scrubbing solution. To use the scrubbing solution, follow the commercially approved guidelines from the supplier that you purchase the solution from. Just note that if you are using current methods you will be using more solution than you would be using if you are using this invention, this invention decreases your solution requirements by 25 to 60%.

The random packings, 4, are installed when the reaction vessel, 2 is constructed. The random packings are completely filling the vessel. The random packing materials are purchased from commercial suppliers, one such supplier is Koch-Glitsch that are commonly found in separation columns. The materials can be either plastic, ceramic or metal, depending on user preference, costs, components of natural gas, and temperatures. To keep costs and shipping weight down, plastics have been used very successfully in most applications. The random packings also allow the flow rate of natural gas from the input stream, 1, to be either a laminar or turbulent flow, because the flow around the random packings create eddies, causing any laminar flow to exhibit a turbulent flow like profile. The size of the random packings is also dependent on the application. In our trial tests, we have seen that random packing from ¾ to 1 inch work very well, as long as they have a fairly hollow design, much like the FLEXIRING® that Koch-Glitsch produces and sells commercially.

The benefit of the random packings, 4, and how random packing improves the H₂S removal process is the random packing generates a much higher surface area for the reaction to take place. By spreading the scrubbing solution, 3, over the random packing material to create a thin film of the reactive solution and forcing the gas to flow on and over the random packing creates a much more favorable environment for the reaction to take place. By increasing this surface area and making for a much richer environment for the reaction, less of the scrubbing liquid is required for the reaction. This in turn, makes the reaction vessel, 2, to be smaller as well.

After the natural gas has been forced past all of the random packing material, 4, the natural gas exits the reaction vessel, 2, through a port at the top, 5. The natural gas exiting the reactor can then be shipped or sold to gas processing plants. However, this natural gas will be reduced of H₂S. It has been common to see H₂S in the exiting natural gas streams to be more than 95% less than the entering stream, in some applications, H₂S has been virtually undetectable, meaning that this process removes most, if not all of the H₂S from the natural gas stream. All while using much less scrubbing solution, 3.

What is claimed:

1. A process for the removal of H₂S from a gas stream containing H₂S enclosed in a steel vessel, includes the following:
a) a solution of scrubbing chemical, and
b) random packing material.

2. The scrubbing solution described in claim 1 includes, but is not limited to, triazine, the current industry standard for H₂S scrubbing, any other or newly developed scrubbing solution can be applied to the process in claim 1.

3. A process, in accordance with claim 1 may contain any gas stream which has H₂S present that needs to be removed by a reactor or any type of vessel acting as a reactor that is filled a packing material that is coated in a scrubbing chemical solution.

4. The packing material, in accordance with claims 1 and 3 may be of any material, including but not limited to ceramic, plastic, or a metal.

5. The process, described in claim 1 may have any type of flow entering the reactor vessel. The flow profile may be either laminar or turbulent in nature.

6. The packing material in claim 3 and claim 5 creates a turbulent type flow even for the laminar fluids and drives the gas into the liquid interface at the surface of the packing material.

7. The process in accordance to claim 1, drives the conversion reaction between the H₂S and the scrubbing solution. The greater the surface area of the packed material, the more favorable the reaction.

8. The process, described in claim 7, will result in the decrease in the amount of scrubbing material needed for the removal of H₂S from the gas stream. The reduction of scrubbing chemicals is reduced by 25 to 60%.

9. The reduction in scrubbing chemicals, described in claim 8, is tied directly to the size of the reactor equipment, resulting in a reduction of reactor size, generally by the same percentage of the reduction of scrubbing chemicals, 25 to 60%.

10. The process in accordance with claim 1 reduces the amount of H₂S from a standard natural gas stream from an oil and/or gas well by at least 95%.
